(19) United States
(12) Patent Application Publication
(10) Pub. No.: US 2009/0117504 A1
(43) Pub. Date: May 7, 2009

(54) Furnace assembly

(76) Inventor: Robert Grunenfelder, Eschen (LI)

Correspondence Address: John C. Thompson, 69 Grayton Road, Tonawanda, NY, 14150, US

(21) Appl. No.: 12/291,357

(22) Filed: Nov. 7, 2008

(30) Foreign Application Priority Data
Nov. 7, 2007 (DE) P102007053071.6

(51) Int. Cl. F27B 21/14; G05D 23/30; A61C 13/20

(52) U.S. Cl. 432/51; 432/32; 700/209; 433/215

(57) ABSTRACT

The invention relates to a furnace assembly for dental technology, in particular for ceramic dental compositions, comprising a display device associated with a furnace assembly (10), which may be designed in the manner of a touchscreen, and comprising a control device, which has a data interface by way of which data for controlling the furnace assembly and/or image data (in the form of static images or moving images) can be transmitted. The control device has a packet module, in particular an EDGE, GSM, GRPS and/or UMTS module, by way of which control data and/or image data for presentation on the display device can be transmitted in the form of packets.

### CROSS-REFERENCE TO RELATED APPLICATIONS

This application claims foreign priority benefits under 35 U.S.C. '119(a)-(d) from German patent application ser. no. P 10 2007 053 071.6 filed Nov. 7, 2007.

### TECHNICAL FIELD

The invention relates to a furnace assembly including a control device having a data interface and a display device associated with the control device, and more particularly to a furnace assembly wherein a packet module is associated with the control device for transmitting data and/or images whereby in the case of an erroneous data transmission, it is not necessary to re-transmit all data but only the erroneous data packet.

### BACKGROUND OF THE INVENTION

Furnaces with the possibility of control by way of an external data source were already proposed some time ago, in particular for relatively large dental laboratories. Furthermore, it is known for furnaces to make the data transmission take place bidirectionally, that is to say for example always to signal the occurrence of data transmission or other signals from the furnace.

Furthermore, it was for example also proposed some time ago to signal the end of the firing process by way of a clear acoustic or optical signal, in order to signal to the employees in the dental laboratory the need to take action with respect to the furnace concerned.

An integrated solution in which a bidirectional interface is likewise realized was published not long ago, as can be seen from U.S. Pat. No. 7,001,178. This solution offers the possibility of sending control data, but also for example image data, to the furnace by way of a data input, it being conceivable to realize this by way of an RS-232 interface, a USB interface, or for example by way of a reader for memory cards or for chip cards.

In principle, it is possible specifically for relatively large amounts of data to transmitted quite quickly by way of the high-speed interfaces that are available. This also applies in particular to image data.

In order to keep down the costs of providing the furnace, it is in fact advisable to use the data input both for the transmission of control data and for the transmission of image data, for example for the presentation of images of teeth on the furnace or alongside the furnace. While the transmission of image data is less critical as far as data consistency is concerned, it is very important in the case of the transmission of control data that they are sent to the furnace in the correct form.

In order to ensure reliable data transmission, it is also known per se to add error correction, which aborts the data transmission when a transmission error occurs, and which automatically corrects the errors that may have occurred.

However, this type of data transmission has not become established in the case of furnaces, since, although all furnaces with a data input can receive data in a pure form, the error correction must in each case be coordinated between the receiver and the sender, so that the differences existing between the specific data formats that the furnace needs for its control data prevent the same control data format being used for all furnaces.

Therefore, nowadays control data are typically transmitted to furnaces specifically, and possibly even separately.

Furthermore, in the case of furnaces there is the problem that calibrations are required from case to case. This typically takes place by way of special calibrating programs, which then perform an adjustment between the set temperature and the actual temperature for the temperature curves being followed. Although it would be possible in principle to perform remote calibration, this is often not carried out because there is the risk of this causing errors—whether that of a furnace other than the one desired being calibrated or that of data errors occurring.

The manufacturers of dental ceramics also often develop new ceramics of their own, which use correspondingly adapted firing programs. In order to install these, the firing program concerned is typically fed into the furnace by way of a memory card or the like.

### OBJECTS AND SUMMARY OF THE INVENTION

According to the invention, it is envisaged to transmit both the control data for the furnace and any image data, if the furnace has a display device, in a particular way to the furnace. This involves dividing the data into packets, which each have an independent item of address information and at the same time have an error correction scheme. This then achieves the particularly favorable advantage when erroneous data are transmitted that only the erroneous packet has to be re-transmitted, but not the entire amount of data. This surprisingly has the particularly favorable effect that both quite small amounts of data of high quality—control data—and large amounts of data with lower quality requirements—image data—can be transmitted reliably and in conformity with the respective requirements of the furnace concerned, the use of the same standard surprisingly giving rise to the possibility of realizing the data transmission in the same way for different furnaces, even of different types, even if entirely different control data have to be transmitted.

According to the invention, it is accordingly envisaged to provide data packets of a prescribed length with a header or address bits, which make a unique assignment to the target furnace possible. To this extent, it is the responsibility of the sender of the data, that is for example also the manufacturer of the furnace, to perform the assignment between the control data and the address data correctly. The transmission consequently takes place independently of the quality of the data transmission path, the detection of an erroneous packet resulting in this being signalled and re-transmission of the same data packet being requested.

The length of the data packets can be adapted to the requirements within wide ranges. With preference, a uniform, average packet length is chosen, for example 2 kB. However, it is also possible, and advisable specifically in the case of poorer quality of the data transmission path, to realize a comparatively short packet length such as 512 bits, which is particularly suitable for the transmission of control data. The transmission times of the image data are prolonged for understandable reasons in the case of a reduced data packet length, in accordance with the ratio between payload and overhead data, that is those data that serve for addressing the packet concerned and also for the error checking or error correction, so that in the case of smaller packets an increased amount of data must be transmitted.

This is advisable in particular if a wireless transmission technique is chosen for the transmission path, such as for example by the installation of a GRPS, EDGE or UMTS module, or possibly an HSDPA module, the reduction of the payload transmission rate in relation to the gross data transmission rate becoming ever less critical with increasing speed of the data transmission path.

Alternatively or an addition, it is also possible to operate the furnace by way of an Internet connection and to make the packets take the form of IP packets. The control may then also be performed by way of a web browser, it being possible for the data interface to be realized in any suitable way desired, for example also by way of a LAN which is connected to the Internet by means of a router.

In this case, it is also possible to perform the control or programming of the furnace remotely by way of a VPN or SSH connection.

According to the invention, it is particularly favorable in this context if an image of the screen of the furnace can be shown on a remote screen, for example on that of a cellphone, in a form of reduced resolution, by way of a long-distance data connection. If a touch-sensitive screen is used as the screen, this can be simulated for example by way of a smart phone or a PDA, it also being possible to realize the remote control by means of a customary cursor control by way of a joystick, arrow keys or the like.

According to the invention, it is accordingly provided that the control device of the furnace has a packet module, which provides the correct dividing up and putting together of data from and into packets. This includes, for example, an IP module, but also alternatively an EDGE, GRPS or UMTS module.

In an advantageous refinement of the invention, it is envisaged to perform the data transmission between the furnace and a remote station, which may for example be a cellphone or a remote PC, in an encrypted form. This ensures that no manipulations can be carried out by third parties, which is conducive to the security of the transmission and consequently to the security of the remote control of the furnace.

Furthermore, it is particularly favourable that a modular structure is ensured by the realization of a particular packet module that provides the data transmission function. Such a packet module can accordingly also be used in the case of different furnaces; retrofitting of furnaces with the packet module is also possible.

It is also possible to use the same packet module in different furnaces, namely those for which a screen is provided and those for which no screen is provided. When screenless furnaces are used, the packet module is to this extent used for providing the control data.

According to the invention, it is provided that the image data are transmitted by way of a long-distance data transmission channel, which operates in particular bidirectionally.

In a further advantageous refinement, it is provided that the receiving format of the control device for the data corresponds to the transmitting format of an SMS for the control data and/or the transmitting format of an MMS for the image data.

In a further advantageous refinement, it is provided that the control data are automatically separated from the image data on reception in the furnace.

In a further advantageous refinement, it is provided that the image data have or are accompanied by identification data, with which information on the image data concerned can be transmitted simultaneously with the transmission of static images or moving images, in particular films.

In a further advantageous refinement, it is provided that confirmation information on the firing process in the furnace and/or the orders processed and/or the tooth colors used and/or further dental parameters can be transmitted, in particular to the client, by way of the data interface of the furnace.

In a further advantageous refinement, it is provided that each packet of the image data has an item of information on its target address, namely the furnace.

In a further advantageous refinement, it is provided that the display device, in particular a screen of the furnace, has at least one touch-sensitive region, by way of which keyboard functions can be transmitted to the control device of the furnace.

In a further advantageous refinement, it is provided that the furnace has a loudspeaker and/or a microphone, by way of which the furnace operates in the manner of a cellphone, and that the control device has in particular an SMS function and/or an MMS function, by way of which text messages and/or image data can be sent from the furnace.

In a further advantageous refinement, it is provided that information for an update can be transmitted to the control device by way of the packet module.

In a further advantageous refinement, it is provided that it is possible while the furnace is being operated to switch on a help mode, by way of which information and data for operating the furnace can be transmitted, in particular wirelessly, to the corresponding furnace and can be displayed on the screen.

In a further advantageous refinement, it is provided that the furnace can be remotely controlled by way of the data interface and the packet module.

In a further advantageous refinement, it is provided that an operator interface of the remote control can be displayed on the screen of the furnace.

In a further advantageous refinement, it is provided that the data transmission itself has an error correction and, when erroneous data are detected, only these are re-transmitted.

In a further advantageous refinement, it is provided that the error correction and/or an error check takes place exclusively on the level of the data transmission, that is to say the control data themselves are transmitted without a check bit or the like.

In a further advantageous refinement, it is provided that the control data have address information, which defines how the furnace that is respectively to be controlled is to be addressed.

In a further advantageous refinement, it is provided that the touch-sensitive region of the screen also has cursor control functions, by way of which cursor function positioning of objects on the screen can also be realized.

### BRIEF DESCRIPTION OF THE FIGURES

Further advantages, details and features emerge from the following description of an exemplary embodiment on the basis of the drawing, in which:

FIG. 1 shows a schematic representation of a furnace according to the invention in one embodiment;

FIG. 2 shows a modified embodiment of the furnace according to FIG. 1.

### DETAILED DESCRIPTION

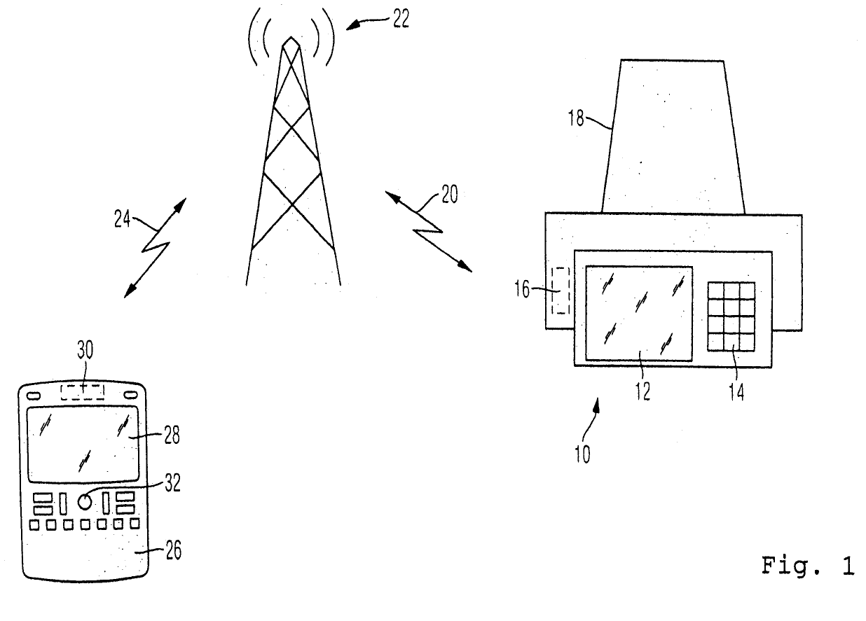

The furnace assembly 10 represented in FIG. 1 has a display device 12, on which signals and data concerning the furnace, such as for example furnace parameters, can be presented in a way known per se. The choice of presentation and the direct control of the furnace likewise take place in a way known per se. If the display device 12 has a touch-sensitive screen, the control can be performed directly there. In the exemplary embodiment represented, a keyboard 14 is provided, by way of which the control takes place in a display-related manner, for example by arrow keys being used to move a cursor and the desired function being initiated.

In addition, the display device 12 is capable of presenting images of dental restoration parts and/or teeth of patients. The data concerned can be readily produced from photographs of neighboring teeth of the tooth to be created, it being possible for example to set the choice of which detail is presented on the screen.

According to the invention, a packet module 16, which according to the invention makes the data exchange possible in a special way, is provided in the furnace. The packet module 16 is part of a control device 18 of the furnace that is intended for providing the firing curves etc. and also ensures that the furnace parameters of a firing process that are prescribed by way of the keyboard 14 and displayed on the display device 12 are maintained.

Even if the packet module 16 is represented here as part of the control device 18, this relates in principle to the logical assignment of the packet module 16 to the control device 18. Accordingly, a physical separation is also possible, for example in that the packet module 16 is connected to the furnace assembly 10 as a kind of adapter. Combination with a modem is also possible.

The packet module 16 allows packet transmission of data by way of a transmission path 20. In the exemplary embodiment represented, electromagnetic waves are provided as the medium, transmitted in the form of GRPS data by way of a base station 22 with a corresponding antenna. The data are transmitted by way of a corresponding transmission path 24 to and from a cellphone 26, which has a comparatively large screen 28 for the visual presentation of suitable signals. For example, the screen 28 of the cellphone 26 may be designed as a reduced copy of the display device 12, or certain selected data may be displayed in a compact form.

The cellphone 26 has a mobile module 30, which undertakes the preparation of the packet data and to this extent is compatible with the packet module 16. The data are transmitted together in packets, each with address information and error correction data, so that a reliable data transmission can be realized even in the case of poor transmission quality of the transmission path.

Even if electromagnetic waves are envisaged here as the primary transmission medium, it goes without saying that any other suitable data medium desired may be provided. For example, the realization of LAN connections comes into consideration. If, for example, a WLAN or a LAN connection is used, a PC, which possibly can be connected to the packet module 16 by way of a router and the Internet, may be used instead of the cellphone 26 as the controlling terminal.

During the operation of the furnace according to the invention, the furnace assembly 10 can be controlled by way of the cellphone 26, using its cursor that can be controlled by way of a joystick 32, with the presentation of the display taking place in parallel on the screen 28 and the display device 12. It is also possible to provide what is known as a master function, with which, for example, the manufacturer of the furnace or a competent technical adviser shows the dental technician the possibilities and settings. In this case, control of the furnace assembly 10 by way of the cellphone 26 has priority over operation by way of the keyboard 14.

It is also possible for example by way of the cellphone to transmit the desired images in the form of an MMS; the control data may also be transmitted for example in the form of an MMS, and also a software update can be readily realized for example by way of a JAVA program.

The same applies correspondingly if a PC is used as the device: in this case, the transmission of new firing parameters, for example for a newly developed ceramic, is possible extremely easily, and it is also ensured by the error-corrected packet data transmission that incorrect furnace control does not occur.

Furthermore, there is also the possibility of performing a remote calibration or even remote maintenance with functional checking of the furnace control.

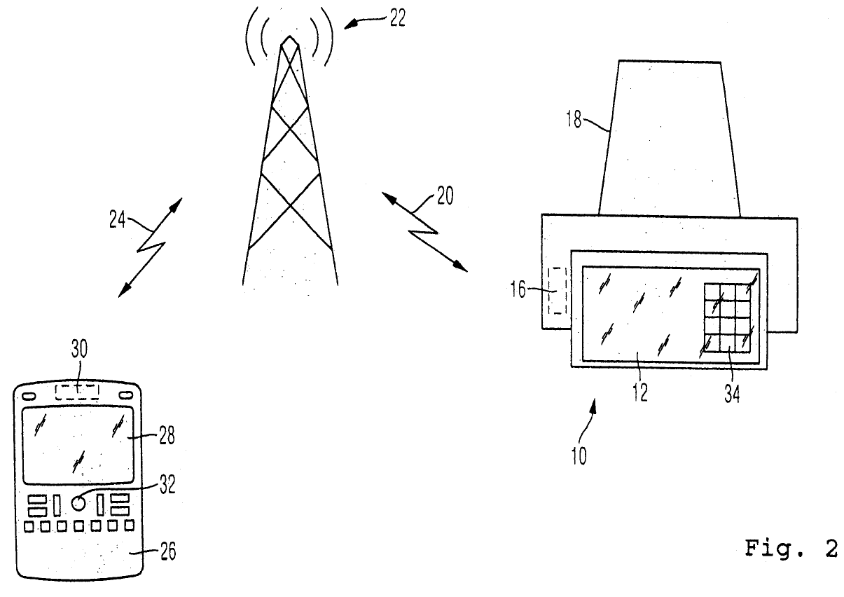

The embodiment of the furnace that is represented in FIG. 2 differs from that according to FIG. 1 in that an enlarged screen is provided as the display device 12 on the furnace assembly 10. At least part of the screen is formed in a touch-sensitive manner as what is known as a touchscreen 34, it being possible to use this touch-sensitive region for initiating both keyboard functions and, for example, cursor functions. Cursor functions can be initiated for example by the user moving a finger in a specific direction.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. A furnace assembly for dental technology, in particular for ceramic dental compositions, comprising a display device, a control device associated with the display device, which control device has a data interface by way of which data for controlling the furnace assembly and/or image data (in the form of static images or moving images) can be transmitted, characterized by the control device (18) having a packet module (16), in particular an EDGE, GSM, GRPS and/or UMTS module, by way of which control data and/or image data for presentation on the display device (12) can be transmitted in the form of packets.

2. The furnace assembly as claimed in claim 1, wherein the image data are transmitted by way of a long-distance data transmission channel, which operates in particular bidirectionally.

3. The furnace assembly as claimed in claim 1, wherein the receiving format of the control device (18) for the data corresponds to the transmitting format of an SMS for the control data and/or the transmitting format of an MMS for the image data.

4. The furnace assembly as claimed in claim 1, wherein the control data is automatically separated from the image data on reception in the furnace assembly (10).

5. The furnace assembly as claimed in claim 1, wherein the image data is accompanied by identification data, with which information on the image data concerned can be transmitted simultaneously with the transmission of static images or moving images, in particular films.

6. The furnace assembly as claimed in claim 1, wherein confirmation information on the firing process in the furnace assembly (10) and/or the orders processed and/or the tooth colors used and/or further dental parameters can be transmitted, in particular to the client, by way of the data interface of the furnace assembly (10).

7. The furnace assembly as claimed in claim 1, wherein each packet of the image data has an item of information on its target address, namely the furnace assembly (10).

8. The furnace assembly as claimed in claim 1, wherein the display device (12), in particular a screen (12) of the furnace assembly (10), has at least one touch-sensitive region (34), by way of which keyboard functions can be transmitted to the control device (18) of the furnace assembly (10).

9. The furnace assembly as claimed in claim 1, wherein the furnace assembly (10) has a loudspeaker and/or a microphone, by way of which the furnace assembly (10) operates in the manner of a cellphone (26), and wherein the control device (18) has in particular an SMS function and/or an MMS function, by way of which text messages and/or image data can be sent from the furnace assembly (10).

10. The furnace assembly as claimed in claim 1, wherein information for an update can be transmitted to the control device (18) by way of the packet module (16).

11. The furnace assembly as claimed in claim 1, wherein it is possible while the furnace assembly (10) is being operated to switch on a help mode, by way of which information and data for operating the furnace assembly can be transmitted, in particular wirelessly, to the corresponding furnace assembly (10) and can be displayed on the screen (28).

12. The furnace assembly as claimed in claim 1, wherein the furnace assembly (10) can be remotely controlled by way of the data interface and the packet module (16).

13. The furnace assembly as claimed in claim 1, wherein an operator interface of the remote control can be displayed on the screen (28) of the furnace assembly (10).

14. The furnace assembly as claimed in claim 1, wherein the data transmission itself has an error correction and, when erroneous data are detected, only these are re-transmitted.

15. The furnace assembly as claimed in claim 1, wherein the error correction and/or an error check takes place exclusively on the level of the data transmission, that is to say the control data themselves are transmitted without a check bit or the like.

16. The furnace assembly as claimed in claim 1, wherein the control data have address information, which defines how the furnace assembly (10) that is respectively to be controlled is to be addressed.

17. The furnace assembly as claimed in claim 8, wherein the touch-sensitive region of the screen (34) also has cursor control functions, by way of which cursor function positioning of objects on the screen can also be realized.
